(19) United States
(12) Patent Application Publication
(10) Pub. No.: US 2010/0133707 A1
(43) Pub. Date: Jun. 3, 2010

(54) Ultrasonic Humidifier with an Ultraviolet Light Unit

(76) Inventor: Chih-Li Huang, Tainan City (TW)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/325,645

(22) Filed: Dec. 1, 2008

(51) Int. Cl. B01F 3/04

(52) U.S. Cl. 261/81; 261/DIG. 48; 422/4; 422/20; 422/24; 422/121

(57) ABSTRACT

An ultrasonic humidifier includes a base that is formed with a recess, as well as a water tank and a mist spraying tube that are disposed on the base and that are in fluid communication with the recess. An ultrasonic oscillator is disposed in a bottom end of the recess for atomizing water in the recess. An ultraviolet light unit is disposed in said mist spraying tube.

### BACKGROUND OF THE INVENTION

1. Field of the Invention

This invention relates to a humidifier, and more particularly to an ultrasonic humidifier.

2. Description of the Related Art

Referring to FIG. 1, a conventional ultrasonic humidifier 1 includes a base 11, a water tank 12 disposed on the base 11, a mist spraying tube 13 disposed on the water tank 12, and an ultrasonic oscillator 14 disposed on the base 11. The base 11 has a top surface that is formed with a recess 111 in fluid communication with the water tank 12 and the mist spraying tube 13. The ultrasonic oscillator 14 is disposed in a bottom end of the recess 111.

In use, the water tank 12 is filled with an amount of water to be atomized. The water flows from the water tank 12 into the recess 111 to contact the ultrasonic oscillator 14. Hence, the water in the recess 111 is atomized to form mist. The mist is blown into the atmosphere through the mist spraying tube 13 to increase the moisture in the ambient air.

To obtain high-quality humidified air, it is necessary to fed high-quality water into the water tank 12 and maintain cleanness within the ultrasonic humidifier 1. In addition, when bacteria grow in the ultrasonic humidifier 1, it is necessary to kill the bacteria. However, the aforesaid ultrasonic humidifier 1 cannot solve the bacteria growth problem. As a result, the bacteria will be moved along with the mist from the ultrasonic humidifier 1 into the humidified air. Thus, the humidified air may be harmful to heath and/or creates unpleasant odor.

### SUMMARY OF THE INVENTION

The object of this invention is to provide an ultrasonic humidifier that includes an ultraviolet light unit for sterilizing mist in the humidifier.

According to this invention, an ultrasonic humidifier includes a base that is formed with a recess, as well as a water tank and a mist spraying tube that are disposed on the base and that are in fluid communication with the recess. An ultrasonic oscillator is disposed in a bottom end of the recess for atomizing water in the recess. An ultraviolet light unit is disposed in said mist spraying tube.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a partly sectional side view of a conventional ultrasonic humidifier;

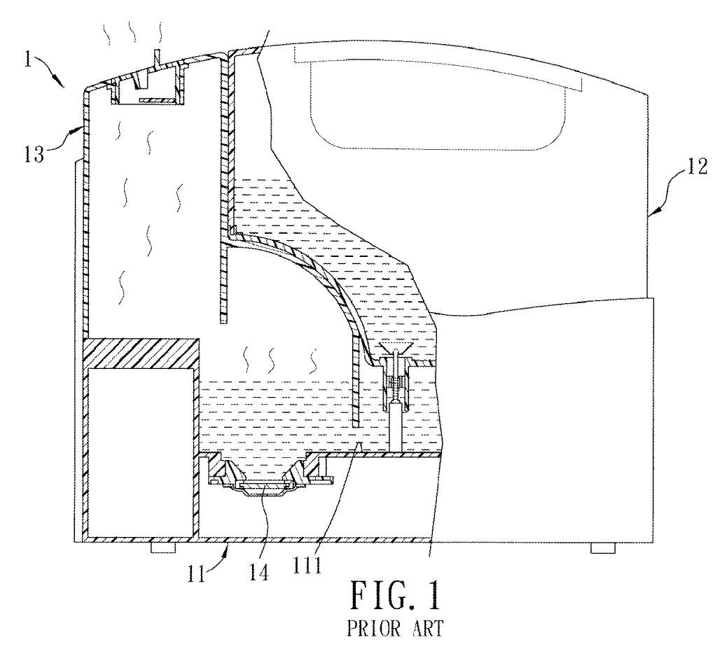

FIG. 2 is a partly exploded perspective view of the first preferred embodiment of an ultrasonic humidifier according to this invention;

FIG. 3 is a partly sectional side view of the first preferred embodiment; and

FIG. 4 is a partly sectional side view of the second preferred embodiment of an ultrasonic humidifier according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

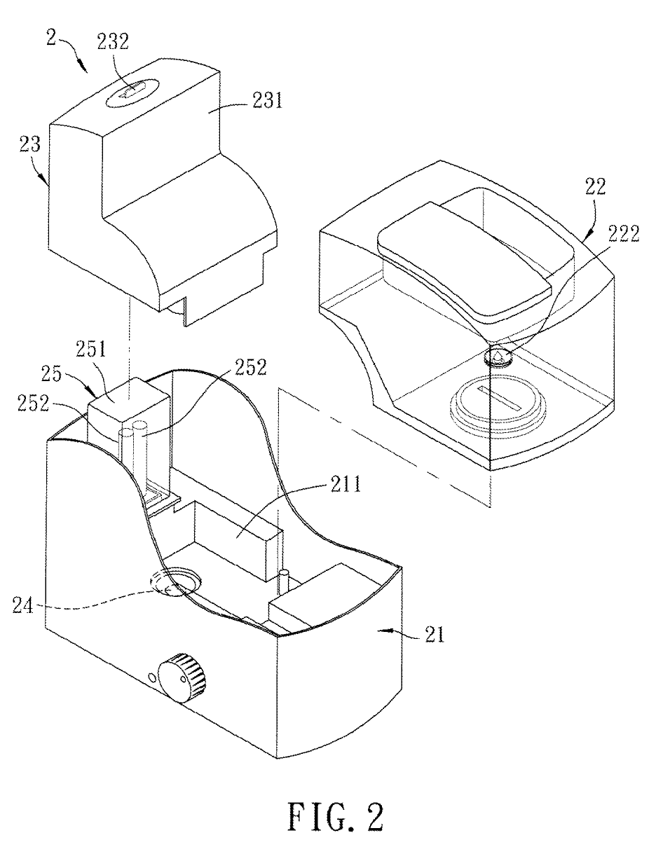

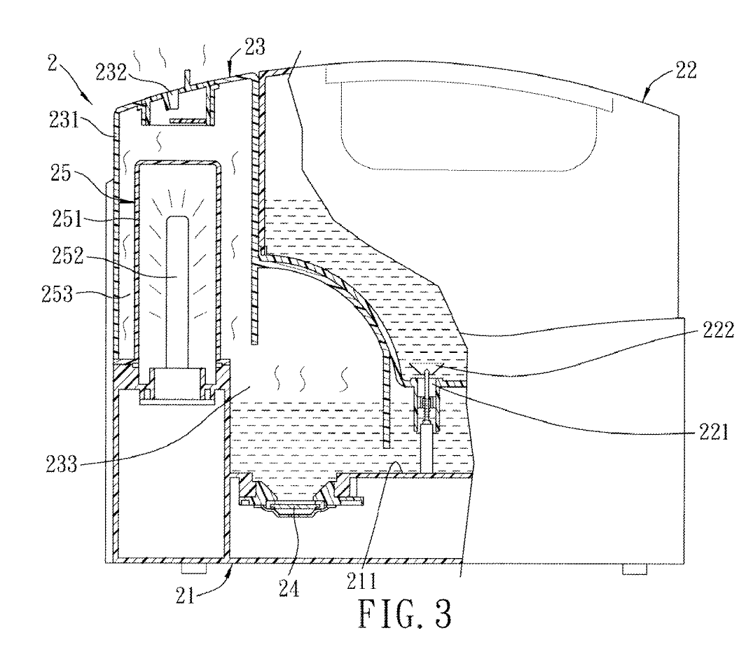

Referring to FIGS. 2 and 3, the first preferred embodiment of an ultrasonic humidifier 2 according to this invention includes a base 21, a water tank 22 disposed on the base 21, a mist spraying tube 23 disposed on the base 21, an ultrasonic oscillator 24 disposed in the base 21, and an ultraviolet light unit 25 disposed in the mist spraying tube 23.

The base 21 has a top surface that is formed with a recess 211.

The water tank 22 has a water supply port 221 in fluid communication with the recess 211 in the base 21, and a valve 222 disposed within the water supply port 221 in a known manner for controlling opening and closing of the water supply port 221.

The mist spraying tube 23 includes a tube body 231 disposed on the base 21 and having a mist outlet 232 disposed at an upper end thereof and in fluid communication with the environment, and a mist inlet 233 disposed at a lower end thereof and in fluid communication with the recess 211 in the base 21.

The ultrasonic oscillator 24 is disposed in a bottom end of the recess 211 in the base 21.

The ultraviolet light unit 25 includes a light shield 251 disposed in the mist spraying tube 23, and two upright ultraviolet lamps 252 disposed within the light shield 251. An inner wall surface of the mist spraying tube 23 cooperates with an outer wall surface of the light shield 251 to define an annular mist passage 253 therebetween, which is in fluid communication with the recess 211 in the base 21. The number of the ultraviolet lamps 252 may be changed.

In use, the water tank 22 is filled with an amount of water to be atomized. The water flows from the water tank 22 into the recess 211 in the base 21 via the water supply port 221. Subsequently, the ultrasonic oscillator 24 is driven to atomize the water in the recess 211 in the base 21 to form mist. The mist is blown into the atmosphere through the mist spraying tube 23 in a known manner to increase the moisture in the ambient air. During flow of the mist through the mist spraying tube 23, the ultraviolet light emitted from the lamps 252 can sterilize the mist in the mist spraying tube 232 by killing bacteria or germs in the mist and enhance oxidation and decomposition of organic substances in the mist, thereby promoting the quality of the humidified air.

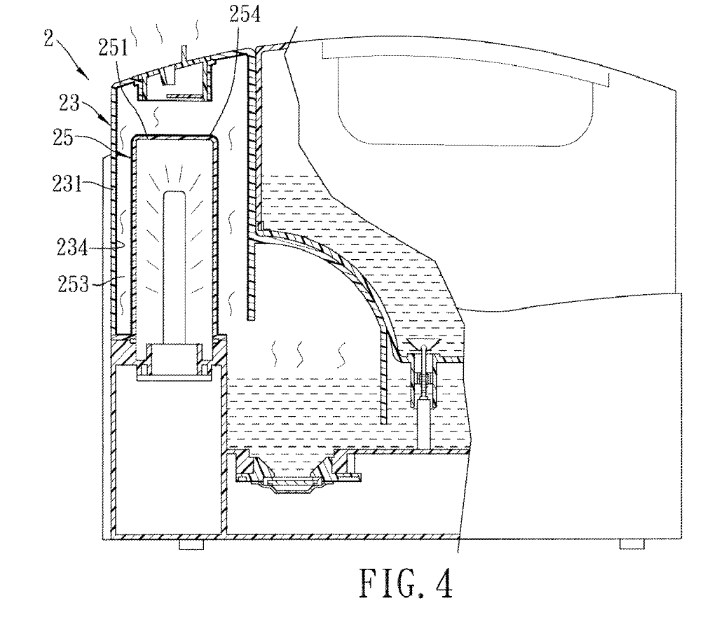

FIG. 4 shows the second preferred embodiment of an ultrasonic humidifier 2 according to this invention, which is similar in construction to the first preferred embodiment. In this embodiment, the mist spraying tube 23 further includes a titanium dioxide coating 234 applied on an inner wall surface of the tube body 231 and exposed within the annular mist passage 253. In addition, the ultraviolet light unit 25 further includes a titanium dioxide coating 254 applied on the outer wall surface of the light shield 251 and exposed within the annular mist passage 253.

During flow of the mist through the mist spraying tube 23, by a photocatalytic reaction of the titanium dioxide coatings 234, 254, free radicals having enhanced oxidizing power are formed to assist in removing harmful microorganisms and organic substances from the mist to thereby purify the humidified air.

With this invention thus explained, it is apparent that numerous modifications and variations can be made without departing from the scope and spirit of this invention. It is therefore intended that this invention be limited only as indicated by the appended claims.

I claim:

1. An ultrasonic humidifier comprising:
a base having a top surface formed with a recess;
a water tank disposed on said base and in fluid communication with said recess in said base;
a mist spraying tube disposed on said base and in fluid communication with said recess in said base;
an ultrasonic oscillator disposed in a bottom end of said recess in said base for atomizing water in said recess in said base to form mist, the mist flowing through said mist spraying tube; and
an ultraviolet light unit disposed in said mist spraying tube for sterilizing the mist flowing through said mist spraying tube.

2. The ultrasonic humidifier as claimed in claim 1, wherein said ultraviolet light unit includes a light shield disposed in said mist spraying tube, and at least one ultraviolet lamp disposed within said light shield, said mist spraying tube having an inner wall surface, said light shield having an outer wall surface that cooperates with said inner wall surface of said mist spraying tube to define an annular mist passage therebetween, said annular mist passage being in fluid communication with said recess in said base.

3. The ultrasonic humidifier as claimed in claim 2, wherein said ultraviolet light unit further includes a titanium dioxide coating applied on said outer wall surface of said light shield and exposed within said annular mist passage.

4. The ultrasonic humidifier as claimed in claim 3, wherein said mist spraying tube includes a tube body disposed on said base and having an inner wall surface constituting said inner wall surface of said mist spraying tube, and a titanium dioxide coating applied on said inner wall surface of said tube body and exposed within said annular mist passage.

5. The ultrasonic humidifier as claimed in claim 1, wherein said mist spraying tube has a mist outlet disposed at an upper end thereof and permitting flow of the mist out of said humidifier therethrough, and a mist inlet disposed at a lower end thereof and in fluid communication with said recess in said base.

6. The ultrasonic humidifier as claimed in claim 1, wherein said water tank has a water supply port in fluid communication with said recess in said base, and a valve for controlling opening and closing of said water supply port in said water tank.
